(19) United States
(12) Patent Application Publication
(10) Pub. No.: US 2017/0282234 A1
(43) Pub. Date: Oct. 5, 2017

(54) DEVICE FOR PARTIAL EMBOSSING OF SEAL BLANKS AND METHOD FOR PARTIAL EMBOSSING OF SEAL BLANKS

(71) Applicant: TSCHEULIN-ROTHAL GMBH, Teningen (DE)

(72) Inventor: Andreas BRIELER, Emmendingen (DE)

(73) Assignee: TSCHEULIN-ROTHAL GMBH, Teningen (DE)

(21) Appl. No.: 15/509,104

(22) PCT Filed: Sep. 8, 2015
(86) PCT No.: PCT/EP2015/001805

§ 371 Date: Mar. 6, 2017

(30) Foreign Application Priority Data
Sep. 8, 2014 (EP) 14003089.1

(51) Int. Cl. B21D 43/22; B65B 7/28; B65D 77/20; B44B 5/00; B21D 35/00

(52) U.S. Cl. CPC B21D 43/22; B44B 5/0019; B21D 35/001; B65D 77/20; B65B 7/2807

(57) ABSTRACT

The device for partially embossing deep-drawn or planar seal blanks that are punched out from a foil strip comprises an embossing die and an adjacent punch. The embossing die in turn comprises a female mould and a male mould, the male mould comprising three-dimensional elements that are arranged in an outer region and in a central region and the male mould and the female mould, in their spatial position, being mounted so as to be rotatable about an axis A that is substantially perpendicular to the foil strip.

The present invention relates to a device for partially embossing seal blanks and to a method for partially embossing seal blanks.

Nowadays, containers for food are often sealed by sealable lids. This is true in particular for food which is consumed directly from the container. In this case, the containers are generally moulded directly in a device, filled with the intended product and subsequently sealed by a seal blank. In another method, prefabricated containers are filled in a machine and sealed by a seal blank. Such devices are known as “fill-seal” machines (FS machines). In this case, the seal blanks required for sealing the container are usually prefabricated seal blanks which are produced in large quantities and are stored or transported in stacks. These seal blanks are often made of aluminium or of a laminate that comprises an aluminium layer. At the food packaging machine, the seal blanks are fed to the above-mentioned fill-seal machines by means of a feed device, for example, and are sealed directly onto the edge of the filled container. The seal blanks, which are often also printed and punched out so as to correspond to the contours of the container, are stacked. Since the seal blanks are transported and delivered in stacks, the seal blanks must be separated again by the feed device and individually fed to a filled container. However, stacking the planar and smooth seal blanks leads to said blanks adhering to one another in the stack with substantial adhesion (glass plate effect). However, the systematic separation of the seal blanks can thus only be controlled with difficulty and it is not ensured that the seal blanks are individually separated and each fed to or sealed onto a container. In order to ensure that individual seal blanks are separated, it is known, for example, to emboss the seal blanks. Although this improves the ability to separate them, it has an adverse effect on any printing of the seal blank insofar as the appearance thereof is adversely affected and parts of the printed information, for example contents information, are made harder to read. Methods are also known in which the embossing is reversed at least in part by crushing, in order to obtain a printing region that has not been embossed. However, it is not possible to completely reverse the embossing process and achieve a smooth surface once again.

EP 0 960 024 discloses a method for only partially embossing lids. The partial embossing of the lid is achieved using read marks on the foil material from which the lid is punched out. These read marks allow proper positioning between the printed parts of the foil and the parts of the foil to be embossed or the embossing dies.

EP 1 790 470 describes a method for partially embossing lids, in which it is possible to adjust the geometric position of the embossing die with respect to the foil strip. The lids are partially embossed so that consecutive lids are not congruently embossed and only every other lid is preferably embossed.

DE 1 940 970 describes stackable closure lids made of a coated foil, and the production thereof. Said lids are produced using one punch and one embossing die, the embossing die being rotatable.

A problem addressed by the present invention is that of providing a device and a method for producing partially embossed seal blanks which can be subsequently processed in a simple and error-free manner.

In the present case, the expressions “partially embossing seal blanks” and “embossing seal blanks over part of the surface” are used synonymously and are understood to mean embossing part of the surface of the seal blank.

The problem is solved by a device according to claim 1 and by a method according to claim 12. Advantageous embodiments of the invention are described in the dependent claims.

A device according to the invention for partially embossing deep-drawn or planar seal blanks that are punched out from a foil strip comprises an embossing die and a punch. The embossing die comprises two half-moulds, a male mould and a female mould. In this case, the desired deep-drawing contour or the three-dimensional relief is reproduced on the male mould by means of a mechanical process. Specifically, the male mould has the three-dimensional relief in a raised and mirror-image form. The counterpart of the male mould, the female mould or stamp, has the three-dimensional relief in the non-reversed and depressed form. On the contoured side of the male mould, three-dimensional elements are arranged in an outer region and in a central region. The male mould and the female mould, in their spatial position, are mounted so as to be rotatable about an axis A which is substantially perpendicular to the foil strip.

In the device according to the invention, the embossing die and punch are combined in one tool. In this case, the foil strip is gradually pushed in the conveying direction or machining direction of the device. By means of a lifting movement, the embossing die, which is arranged upstream of the punch, produces the desired contour or imprint in the seal blank by deep-drawing; before the next lifting movement occurs, the foil strip is moved by means of corresponding conveying means in the conveying direction until the foil strip or the now partially embossed seal blank, or seal blank that is embossed over part of the surface, comes to lie in the position of the punch, where it is punched out from the foil strip during the next lifting movement of the punch. Since the male mould and the female mould of the embossing die are mounted so as to be rotatable about an axis A, which is substantially perpendicular to the foil strip, by simply rotating the male mould and the female mould about the axis A by an angle α, it can be achieved that no two consecutive seal blanks, which come to lie on top of one another in a stack after being punched out, have a congruent imprint. Male moulds and female moulds of the embossing die are rotated by the same angle α at the same time and in the same direction. As a result, undesired adherence of the partially embossed seal blanks to one another during the separating process is simply and advantageously prevented. By rotating the male mould and the female mould relative to the foil strip between each lifting movement, the desired non-congruence is reliably obtained. The partial embossing and the punched-out contour of the seal blank are also more precise due to the embossing die and the punch being arranged directly adjacently. Furthermore, the only partial embossing of the seal blank allows for a better printed image on the seal blank, which printed image is not adversely affected by embossing.

In a preferred embodiment, the embossing die in turn comprises two half-moulds, a male mould and, as the second half-mould, a resilient medium. The male mould is, in its spatial position, mounted so as to be rotatable about an axis A that is substantially perpendicular to a foil strip. The resilient medium assumes the function of the female mould.

The resilient medium is preferably in the form of a stamp pad. In this case, the peripheral contours of the stamp pad preferably correspond to the peripheral contours of the male mould. Said contours are cylindrical or circular-cylindrical, for example. The male mould and resilient medium are precisely aligned, i.e. the axes thereof, which are substantially perpendicular to a foil strip, are aligned. The resilient medium does not have a three-dimensional relief in the non-reversed and depressed form, as is the case for a conventional female mould. This is not necessary owing to the resilient medium. The foil strip is embossed over part of its surface by the resilient medium exerting a sufficiently large pressure to the foil strip located between the resilient medium and the male mould. Since the resilient medium does not have a three-dimensional relief, it is not necessary for it to be mounted so as to be rotatable about an axis A that is substantially perpendicular to a foil strip. The resilient medium is therefore preferably not mounted so as to be rotatable about the axis A. This simplifies the design of the embossing die.

The resilient medium can have any form for producing a sufficiently large stamp pressure.

The resilient medium preferably has the form of a stamp pad, the peripheral contours of which correspond to those of the male mould.

The resilient medium preferably comprises hard rubber. Additional resilient media, for example plastics, for example elastomers, preferably thermoplastic elastomers, can also be used.

In a preferred embodiment, the three-dimensional elements are arranged randomly in the outer region and in the central region. The three-dimensional elements are particularly preferably arranged randomly in the outer region.

In another embodiment, the three-dimensional elements are arranged on circular lines, preferably at regular intervals, in the outer region and in the central region of the male mould.

The three-dimensional elements can have different forms. For example, they can be cylindrical, preferably circular-cylindrical projections which extend away from the surface of the male mould substantially perpendicularly.

In another preferred embodiment, the individual three-dimensional elements have different heights. In other words, the male mould comprises three-dimensional elements, some of which have a first height while the remaining three-dimensional elements have a second height that is different from the first height. It is also possible that there are even more groups of three-dimensional elements which have a third and a fourth height, for example.

In another embodiment, the male mould is mounted so as to be rotatable by an angle α. In this case, the angle α corresponds to the central angle of a segment of a circle, which is defined by two adjacent three-dimensional elements.

In a preferred embodiment, the angle α is in a range of from 2° to 90°, particularly preferably in a range of from 3° to 45° and more particularly preferably in a range of from 4° to 15°.

As explained above, the three-dimensional elements can be of different designs and have different heights, for example. In a preferred embodiment, the three-dimensional elements have a height in the range of from two to five times the thickness of the foil strip. Particularly preferably, they have a height in the range of from three to four times the thickness of the foil strip. In this case, all of the three-dimensional elements can in turn have the same height within the given ranges, or the three-dimensional elements have two or more different heights. In addition, the effect of the stacked seal blanks adhering to one another is reduced owing to three-dimensional elements of different heights.

A typical thickness of foils or foil strips, which are used for the production of seal blanks according to the invention, is in the range of from 20 μm to 50 μm, preferably in a range of from 24 μm to 40 μm and particularly preferably in the range of from 30 μm to 36 μm. Two examples of typical thicknesses for the foils used are 25 μm and 35 μm. The particularly preferred ranges for the height of the three-dimensional elements can be determined therefrom, which height corresponds to three to four times the thickness of the foil strip used. The height of the three-dimensional elements is in the range of from 60 μm to 200 μm, preferably in the range of from 72 μm to 160 μm and particularly preferably in the range of from 90 μm to 144 μm. The ranges for the height of the three-dimensional elements, which ranges correspond to two to five times the foil thickness, can correspondingly be determined. The height of a three-dimensional element is measured from the foil surface, from the side of the foil on which the three-dimensional elements protrude, as far as the tip or end face of a three-dimensional element.

In another preferred embodiment, the region of the male mould comprising outer three-dimensional elements directly adjoins the edge of the male mould. Furthermore, the outer region is arranged concentrically with the central region. The central region also comprises three-dimensional elements on its outer periphery.

The contour or the periphery of the female mould and the male mould of the embossing die is adapted to that of the seal blank. The same is also true for the contour of the punch. In a preferred embodiment, the female mould and the male mould of the embossing die have a circular contour or a circular periphery.

In another preferred embodiment, the embossing die and the punch are arranged adjacently and the two tools can be operated synchronously.

The method according to the invention for producing partially embossed seal blanks for containers, in particular for food, is carried out on a device as described(above. In this case, a continuous foil strip is fed to the device over rollers. The foil strip is preferably already pre-printed and then wound onto a reel. The continuous foil strip comprising the pre-printed seal blanks is fed to the embossing die. The foil strip is conveyed gradually and the foil strip is stationary between the advance steps. The partial embossing of the seal blank is produced during the stoppage by means of a lifting movement by the embossing die or the male mould thereof. The lifting movement of the embossing die can also be carried out by means of the female mould or the resilient medium. In the subsequent feed step, the foil strip or the now partially embossed seal blank is moved forwards in the conveying direction and positioned above the punch. During the next lifting movement of the punch, the partially embossed seal blank is punched out and stacked by means of a collection channel. Between two lifting movements of the punch, the male mould and the female mould of the embossing die are rotated by at least an angle α about an axis A that is substantially perpendicular to the foil strip.

The embossing die and the punch are preferably operated synchronously; in other words, for each lifting movement of the punch, the surface of the foil strip or of the seal blank that has not yet been punched out is partially embossed.

If the method is carried out by a device according to the invention, the embossing die of which comprises two half-moulds, a male mould and a resilient medium, there is preferably no rotational movement of the resilient medium, which assumes the function of the female mould. In this case, it is advantageously sufficient for the male mould to be rotated by an angle α between two lifting movements of the punch.

In a preferred embodiment, the angle α is in a range of from 2° to 90°, particularly preferably in a range of from 3° to 45° and more particularly preferably in a range of from 4° to 15°. In a current embodiment, the angle α=4.39°. The male mould is therefore rotated by an angle of rotation of 4.39° between two lifting movements. Advantageously, the angle α is small, and therefore the rotation of the male mould does not limit the speed in the process.

In a preferred embodiment, after a first rotation by the angle α between two lifting movements, the male mould and the female mould are rotated back by an angle α in the opposite direction of rotation.

The device according to the invention will be described in more detail by means of an embodiment shown in the purely schematical drawings, in which:

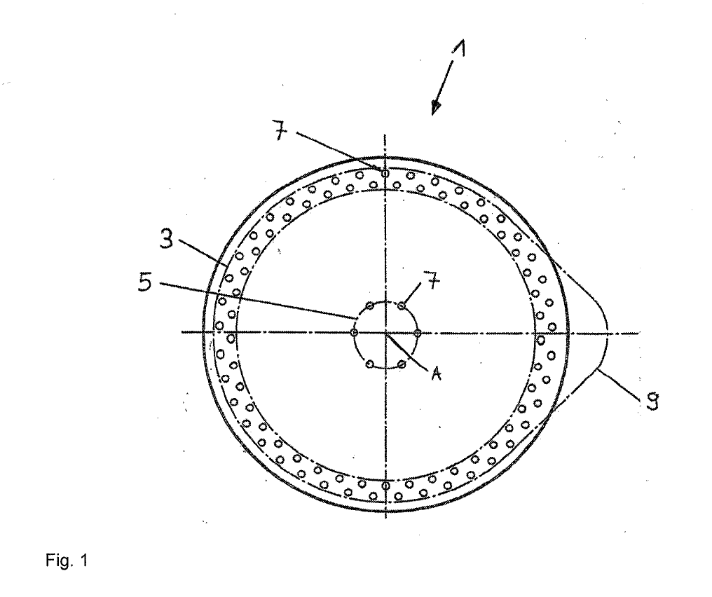

FIG. 1 is a plan view of a male mould;

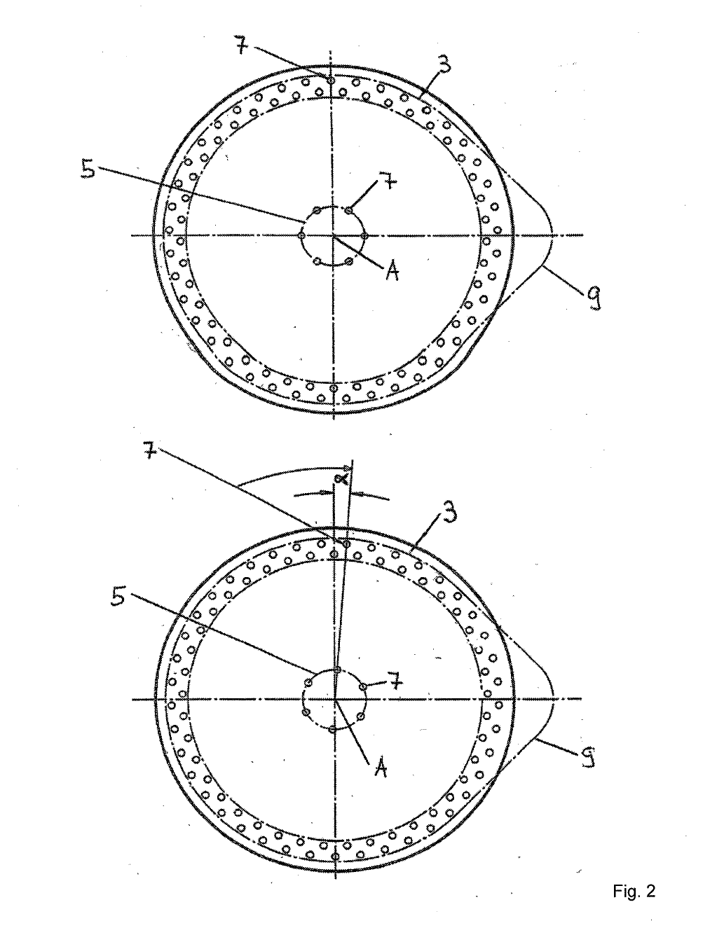

FIG. 2 is a plan view of a male mould, in which said male mould can be seen in two different positions; and

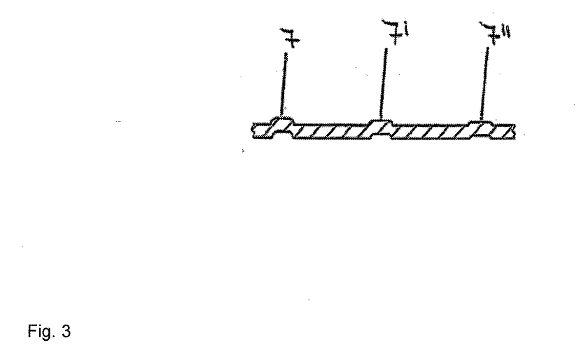

FIG. 3 is a cross section through a detail of a male mould.

FIG. 1 is a plan view of a male mould 1 of an embossing die. The male mould 1 is mounted so as to be rotatable about an axis A and comprises an outer region 3 and a central region 5. Both the outer region 3 and the central region 5 comprise three-dimensional elements 7. In the embodiment shown, the three-dimensional elements 7 are arranged on two concentric circle lines in the outer region 3. The central region 5 also comprises three-dimensional elements 7 arranged on its circular periphery. However, the region between the outer region 3 and the central region 5 is free from three-dimensional elements 7.

Furthermore, the contour of the seal blank 9 is shown, the periphery of which extends virtually as far as the edge of the male mould 1.

FIG. 2 shows the male mould 1 from FIG. 1 in two different rotational positions. In this case, the male mould 1 has been rotated by an angle α from the first rotational position into the second rotational position. The three-dimensional elements 7, which are arranged on two concentric circular lines in the outer region 3 of the male mould 1, are offset on the two circular lines such that, after the male mould 1 has been rotated by an angle α about the axis A, which is substantially perpendicular to the male mould, a three-dimensional element 7 from the inner concentric circular line in each case comes to lie in the angular position in which a three-dimensional element 7 from the outer concentric circular line was positioned before the rotation, and vice versa.

FIG. 3 is a cross section through a detail of a male mould 1 comprising three-dimensional elements 7, 7′ and 7″ that have different heights.

1. A device for embossing and punching out part of the surface of seal blanks from a foil strip by means of an embossing die, comprising two half-moulds, a male mould and a female mould, and a punch, wherein the male mould comprises three-dimensional elements arranged in an outer region and in a central region and wherein the male mould and the female mould, in their spatial position, are mounted so as to be rotatable about an axis A that is substantially perpendicular to a foil strip.

2. A device according to claim 1, wherein the embossing die comprises two half-moulds, a male mould and a resilient medium, and wherein the male mould, in its spatial position, is mounted so as to be rotatable about an axis A that is substantially perpendicular to a foil strip.

3. A device according to claim 2, wherein the resilient medium comprises hard rubber.

4. A device according to claim 1, wherein the three-dimensional elements are arranged randomly.

5. A device according to claim 1, wherein the three-dimensional elements are arranged on circular lines.

6. A device according to claim 1, wherein the three-dimensional elements have different heights.

7. A device according to claim 1, wherein the male mould is mounted so as to be rotatable by an angle α, the angle α corresponding to the central angle of a segment of a circle which is defined by two adjacent three-dimensional elements.

8. A device according to claim 1, wherein the three-dimensional elements have a height in the range of from two to five times greater than a thickness of the foil strip, the foil strip having a thickness in the range of from 20 μm to 50 μm.

9. A device according to claim 1, wherein the region of the male mould comprising outer three-dimensional elements adjoins the edge of the male mould and is arranged concentrically with the central region comprising three-dimensional elements.

10. A device according to claim 1, wherein the female mould and the male mould of the embossing die are circular.

11. A device according to claim 1, wherein the embossing die is arranged adjacently to the punch, and wherein the two tools can be operated synchronously.

12. A method for producing optionally printed seal blanks for containers, the surface of which blanks is partially embossed, wherein the method is carried out on a device according to claim 1, the seal blanks being punched out of a foil strip whose surface is partially embossed, wherein the male mould and female mould, in their spatial position mounted so as to be rotatable about an axis A that is substantially perpendicular to the foil strip, are rotated by at least an angle α between two lifting movements of the punch.

13. A method according to claim 12, wherein, after being rotated by the angle α between two lifting movements, the male mould and the female mould are rotated back by an angle α in the opposite direction of rotation.

14. A device according to claim 1, wherein the three-dimensional elements are arranged on circular lines at regular intervals.

15. A device according to claim 1, wherein the three-dimensional elements have a height in the range of from three to four times greater than a thickness of the foil strip, the foil strip having a thickness in the range of from 24 μm to 40 μm.

16. A device according to claim 1, wherein the three-dimensional elements have a height in the range of from three to four times greater than a thickness of the foil strip, the foil strip having a thickness in the range of from 30 μm to 36 μm.
